(19) United States
(12) Patent Application Publication
(10) Pub. No.: US 2010/0324954 A1
(43) Pub. Date: Dec. 23, 2010

(54) COMPUTER - IMPLEMENTED METHOD AND SYSTEM FOR MONITORING QUALITY IN PRODUCT AND/OR SERVICE ASSOCIATED PROJECTS BY APPLICATION OF IMPROVEMENT IN SIX SIGMA METHODOLOGY

(76) Inventor: Mahesh CHINNAGIRI, Bangalore (IN)

Correspondence Address: HAMRE, SCHUMANN, MUELLER & LARSON, P.C., P.O. BOX 2902, MINNEAPOLIS, MN, 55402-0902, US

(21) Appl. No.: 12/785,903

(22) Filed: May 24, 2010

Related U.S. Application Data
(63) Continuation-in-part of application No. 11/063,306, filed on Feb. 23, 2005, now abandoned.
(60) Provisional application No. 60/546,257, filed on Feb. 23, 2004.

(51) Int. Cl. G06Q 10/00

(52) U.S. Cl. 705/7

(57) ABSTRACT

A computer-implemented method and system for monitoring quality in product and/or service associated projects by the application of improvement in Six Sigma methodology. The method involves accepting as input values associated with a product and/or service to be improved, subsequent to the completion of the project. Then, the values associated with the product or service to be improved are measured over a timeframe having a plurality of time segments, such that each value corresponds to one among the plurality of time segments. Subsequently, a set of values among the plurality of values are determined, corresponding to the plurality of time segments, which correspond to a predefined criterion. By applying predefined comparison criterion, a resultant parameter, whose variation indicates level of quality, is obtained. An output representing the resultant parameter is obtained in the form of a Capability Measurement Diagram and a Moving Loss table.

### FIELD

The disclosure relates generally to a method and system of monitoring product and/or service progress for the purpose of improving quality and determining accurately, if there is a concrete improvement in comparison with the existing quality levels.

More particularly, the disclosure relates to a computer-implemented method and system for monitoring progress in a product and/or service associated projects by application of an improvement in the Six Sigma methodology.

### BACKGROUND

In the present scenario, the level of competition in the marketing of products and rendering of services is very stringent. As a result, commercial and manufacturing entities are very particular about monitoring the quality of products and services rendered. However, describing a product as being of good quality or otherwise and describing a service likewise in a similar manner is abstract and does not convey to the commercial entity and/or manufacturing entity about the extent of improvement required pertaining to the quality of products produced and services rendered. In this regard, there has been a requirement for the measurement of the level of quality of products produced and services rendered.

Several such tools have been developed and are also being implemented in the state of the art. For example, measurement of the quality of products as well as services rendered is performed via tools such as Lean, Six Sigma and Lean Six Sigma. Other examples of quality and operations management tools are inclusive of, but are not restricted to, Total Quality Management (TQM), European Foundation for Quality Management (EFQM) and Quality Standards from International Organization for Standardization (ISO).

Total Quality Management (TQM) is a business management strategy aimed at embedding awareness of quality in all organizational processes. The ISO 9000 family of standards represents an international consensus on standard management practices with the aim of ensuring that the organization is capable of delivering the product or services that meet the quality requirements of the customer. These practices have been distilled into a set of standardized requirements for a quality management system.

The European Foundation for Quality Management (EFQM) comprises the framework employed for organizational management systems and is designed for helping organizations in their drive towards being more competitive. Regardless of the sector, size, structure or maturity, to be successful, organizations need to establish an appropriate management system. EFQM is a practical tool to help organizations perform by measuring where they are on the path to excellence; helping them understand the gaps, and then stimulating solutions.

Among the available set of quality measurement tools, Six Sigma was originally developed as a set of practices designed to improve manufacturing processes and eliminate defects. It was started at Motorola Corporation in the mid 1980s, when the company discovered that products with a high first pass yield rarely failed in actual use. Then, Motorola set out to creating strategies to reduce defects in its products and in 1988 won the Malcom Baldrige National Quality Award.

In Six Sigma, a defect is defined as any parameter that is capable of leading to customer dissatisfaction. Sigma is a statistical concept that represents that amount of variation present in a process relative to customer requirements or specification. The term “Six Sigma” is derived from the field of statistics known as “Process Capability Studies”. Originally, it referred to the ability of manufacturing processes to produce a very high proportion of output within specification. Processes that operate with “Six Sigma quality” over the short term are assumed to produce long-term defect levels of 3.4 defects per million opportunities (DPMO). Six Sigma's implicit goal is to improve all processes to that level of quality or better. In this regard Six Sigma is practiced as a methodology of process improvement to achieve business excellence and strengthen share value of investors. Six Sigma is a systematic method of using extremely rigorous data gathering and statistical analysis. It also helps in developing corporate strategy and bringing about organizational change by aligning people and processes. Further, Six Sigma is a powerful strategy for achieving breakthrough results. Six Sigma can add to the bottom line by improving processes and reducing errors. Six Sigma initiative in a company is deployed with management commitment, involvement and support, treating Six Sigma as a holistic approach, investing adequate resources, focusing on customer requirements, usage of appropriate tools and techniques. Customer satisfaction is the key to success of any business today and in the future.

When a process operates at the Six Sigma level, the variation is so small that the resulting products and services are 99.9997% defect free. However, not all business processes need to attain this high goal. Companies also use the Six Sigma to identify which of their key business processes would benefit most from improvement and then focus their improvement efforts in that direction.

The Lean Six Sigma for services is a business improvement methodology that maximizes shareholder value by achieving the fastest rate of improvement in customer satisfaction, cost, quality, process speed, and invested capital. Lean focuses on maximizing process velocity, provides tools for analyzing process flow and delay times at each activity in a process, centers on the separation of “value-added” from “non-value-added” work with tools to eliminate the root causes of non-valued activities and their cost.

The practice and implementation of Six Sigma takes the form of projects conducted in phases generally recognized as DMAIC (Define-Measure-Analyze-Improve-Control) or DMADV (Define-Measure-Analyze-Design-Verify).

There are two methods namely “The Discrete Method” and “The Continuous Method” for calculating the performance in terms of the Sigma Level at any given point of time for a Six Sigma project.

Conventionally, the Six Sigma methodology can be applied predominantly subject to two conditions:
(a) When the objective is to have a higher output, for example in a condition inclusive of, but not restricted to, increasing the percentage yield of the organization.
(b) When the objective is to have a lower output, for example in a condition inclusive of, but not restricted to, decreasing the service time in a restaurant.

When the conventional Six Sigma methodology is employed in a condition, in which the objective is to achieve a higher output, it has been found that, even though the system subject to the Six Sigma study has been consistently showing an improvement in performance, the values of Six Sigma (Sigma Level/Sigma Rating) over the period under which the system is subjected to Six Sigma study are not indicative of the substantial improvement in the system. As a result, by merely taking into account the Six Sigma values corresponding to the various time durations over which the system is subjected to Six Sigma study, the Six Sigma values indicated in the output do not clearly indicate to the commercial entity and/or manufacturing entity about the extent of improvement achieved/required pertaining to the quality of products produced and services rendered. As a result, the commercial entity and/or manufacturing entity does not have accurate inputs pertaining to the extent of improvement achieved and the level of improvement yet to be achieved. However, it has been still further found that the Six Sigma indications are accurate after the target has been achieved. As a result, the purpose of using the Six Sigma values is not meaningful.

Similarly, when the conventional Six Sigma methodology is employed in a condition in which the objective is to achieve as low an output as possible, it has been found that, even though the system subject to the Six Sigma study has been consistently showing an improvement in performance, the values of Six Sigma over the period under which the system is subjected to Six Sigma study are not indicative of the substantial improvement in the system. As a result, by merely taking into account the Six Sigma values corresponding to the various time durations over which the system is subjected to Six Sigma study, the Six Sigma values indicated in the output do not clearly indicate to the commercial entity and/or manufacturing entity about the extent of improvement required pertaining to the quality of products produced and services rendered. As a result, the commercial entity and/or manufacturing entity does not have accurate inputs pertaining to the extent of improvement achieved and the level of improvement, yet to be achieved. However, it has been still further found that, the Six Sigma indications are accurate after the target has been achieved. As a result, the purpose of using the Six Sigma values is not meaningful.

In view of the above mentioned deficiency in the existing state of the art, there is a need for a method and system employing which, values of Six Sigma that are reflected at the output, are accurately indicative of the level of quality achieved in the products produced, and services rendered.

Further, there is a need for a method and system employing which, values of Six Sigma reflected at the output, achieved in the products produced and services rendered are calculated in a manner, easy to comprehend by the end user.

Still further, there is a need for a method and system employing which, values of Six Sigma that are reflected at the output, achieved in the products produced and services rendered are calculated in an automated manner.

Furthermore, there is a need for a method and system employing which, values of Six Sigma that are reflected at the output, are accurately indicative of the level of quality achieved in the products produced and services rendered in an efficient manner.

### SUMMARY

A method and system employing which, values of Six Sigma that are reflected at the output, are accurately indicative of the level of quality achieved in the products produced and services rendered.

A method and system employing which, values of Six Sigma that are reflected at the output, achieved in the products produced and services rendered are calculated, and represented in a manner which is easy to comprehend by the end-user.

As mentioned above, the described method and system addresses the flaws in the conventional method of calculating “Sigma Level” or “Sigma Rating” for any project at any given point of time to monitor performance. The described method and system rectifies the fallacy that exists in the Continuous Method of calculation conventionally employed in Six Sigma.

The described method and system can also be used in projects that require a reduction in Cycle Time, Down Time, Inventory and so on. It can be applied to all projects where Lean Six Sigma is in use, hence accurately indicative of the level of quality achieved in the products produced or services rendered. Therefore, the described method and system are deployable in projects in which Six Sigma or its functional variants may be applied. Such variants may be inclusive of, but not restricted to Lean, Lean Six Sigma and the like.

This disclosure also describes a computer—implemented method and system for monitoring quality in product and/or service associated projects by application of improvement in Six Sigma methodology.

A method and system are described that can be termed “Capability Measurement Diagram” and the “Moving Loss”. The method and system encompass within their scope a computer software incorporating the method for monitoring the progress of Six Sigma projects during Six Sigma implementation termed “Capability Measurement Software” with output in the form of “Capability Measurement Diagram” and “Moving Loss”. The capability measurement software can be used to monitor the progress of projects for cases where project objective is of “Lower the Better” type having target as “Maximum X” and for cases where project objective is of “Higher the Better” type having target as “Minimum X”.

In an embodiment, a computer-implemented method is described for monitoring quality in products and/or services associated projects by the application of improvement in Six Sigma methodology.

In one embodiment, a method comprises the step of accepting as input, a plurality of values associated with the product and/or service to be improved, subsequent to the completion of the project. Subsequently, values associated with the product or service to be improved over a timeframe comprising a plurality of time segments, such that each value corresponds to one among the plurality of time segments are measured. Thereafter, a set of values among the plurality of values corresponding to the plurality of time segments, which correspond to a predefined criterion are determined. Subsequently, the set of values are processed arithmetically.

After the processing step is performed, a resultant parameter is obtained, whose variation indicates level of quality of product and/or service to be improved, by using the arithmetic combination of measured parameters, under the influence of set of predefined criterion. Finally, an output representing the resultant parameter for each of the said time segments in the said time frame is obtained.

In an embodiment, a computer-implemented system is described for monitoring quality in product and/or service associated projects by the application of improvement in Six Sigma methodology.

The system comprises means for accepting as input, a plurality of values associated with the product and/or service to be improved, subsequent to the completion of the quality monitoring method.

In an embodiment, the means for accepting input can be an input device such as a computer keyboard through which, the user inputs the values to be fed to the software, which enables the determination of the quality, which the system under study desires to achieve.

Even though the means for accepting as input has been mentioned as a computer key board, it is very apparent to persons skilled in the art that the means for accepting input is inclusive of, but not restricted to, any voice-based or touch-based input that are well-known in the art, in view of such requirements as may be needed to implement the system.

The system further comprises means for measuring values associated with the product or service to be improved over a timeframe comprising a plurality of time segments, such that each value corresponds to one among the plurality of time segments.

The described method and system can be deployed as a computer-implemented method and system. The means for measuring values can be the corresponding component in the computer-implemented software mechanism to measure the values over a period of time. For example, in one embodiment, the period of time comprises a year and the plurality of time segments that in combination comprise the year may be a month.

The system further comprises means for determining a set of values among the plurality of values corresponding to the plurality of time segments which correspond to a predefined criterion.

The means for determining a set of values among the plurality of values corresponding to the plurality of time segments, which correspond to a predefined criterion, can be the corresponding component in the computer-implemented software mechanism. The above mentioned software component and the associated algorithm are described in detail in the present disclosure.

The system further comprises means for measuring parameters associated with the consistency of the values corresponding to the plurality of time segments.

The means for measuring parameters associated with the consistency of the values corresponding to the plurality of time segments can be the corresponding component in the computer-implemented software mechanism. The above mentioned software component and the associated algorithm are described in detail in the present disclosure.

The system further comprises means for processing the measured parameters arithmetically by applying predefined comparison criterion in accordance with two predominant system conditions.

The means for processing the measured parameters arithmetically by applying predefined comparison criterion in accordance with two predominant system conditions can be the corresponding component in the computer implemented software mechanism.

The above mentioned software component and the associated algorithm are described in detail in the present disclosure.

The system further comprises means for obtaining a resultant parameter, whose variation indicates level of quality of product and/or service to be improved, by using the arithmetic combination of measured parameters, under the influence of set of predefined criteria.

The means for obtaining a resultant parameter, whose variation indicates level of quality of product and/or service to be improved, by using the arithmetic combination of measured parameters, under the influence of set of predefined criteria can be the corresponding component in the computer implemented software mechanism.

The above mentioned software component and the associated algorithm are described in detail in the present disclosure.

The system further comprises means for obtaining an output representing the resultant parameter for each of the time segments in the time frame.

The means for obtaining an output representing the resultant parameter for each of the time segments in the time frame may be the display mechanism of the computer unit. Even though the means for obtaining the output has been described as the display mechanism like, for example, the monitor, other forms of output obtainable via, for example the electronic and print media, are possible.

In an embodiment, the output is implemented in the form of a visual representation to monitor the progress of product and/or service associated projects to be improved.

In an embodiment, the values that are input in the system are the Average, Ideal Value, Target Value and Standard Deviation associated with the product and/or service to be improved.

In an embodiment, the two predominant system conditions are “Higher the Better” and “Lower the Better”.

In an embodiment, the output is in the form of a tabular format containing the values of the parameter whose variation indicates level of quality of product and/or service to be improved. The parameter is termed as Moving Loss.

In an embodiment, the output for the Capability Measurement Diagram is in graphical format.

In an embodiment, the Six Sigma values are represented as standard notations along with different colored shades.

In an embodiment, the colored shades represent process deterioration and improvement.

In an embodiment, the thick broken line represents the desired direction of improvement.

### BRIEF DESCRIPTION OF DRAWINGS

FIG. 1 is a tabular representation of a system depicting the output in accordance with the conventional procedure for the “Lower the Better” criterion.

FIG. 2 is a graphical bell-curve representation of a system depicting the output in accordance with the conventional procedure for the “Lower the Better” criterion.

FIG. 3 is a tabular representation of a system depicting the output in accordance with an embodiment of the disclosed procedure for the “Lower the Better” criterion.

FIG. 4 is a tabular representation of a system depicting the output in accordance with an embodiment of the disclosed procedure for the “Lower the Better” criterion.

FIG. 5 is a tabular representation of a system depicting the output in accordance with the conventional procedure for the “Higher the Better” criterion.

FIG. 6 is a tabular representation of a system depicting the output in accordance with an embodiment of the disclosed procedure for the “Higher the Better” criterion.

FIG. 7 is a tabular representation of a system depicting the output in accordance with an embodiment of the disclosed procedure for the “Higher the Better” criterion.

FIG. 8 is a visual representation of a system depicting the output in accordance with an embodiment of the disclosed procedure for the “Lower the Better” criterion.

FIG. 9 is a visual representation of a system depicting the output in accordance with an embodiment of the disclosed procedure for the “Higher the Better” criterion.

The set of illustrations have been enclosed in the present disclosure for the purpose of depicting the general mode of implementation of the disclosed system and method, so that it may provide a complete understanding of the disclosed system and method to a person skilled in the art. Any functional equivalent of the components, and any procedural equivalent of the method, may be used.

Further, the drawings have been enclosed for the purpose of illustration only, and hence, should not be construed to be restricting the scope of the claims in any manner.

### DETAILED DESCRIPTION

Six Sigma is a powerful strategy for achieving breakthrough results. Six Sigma can add to the bottom line by improving processes and reducing errors. Six Sigma initiative in a company will be successful when there is management commitment, involvement and support, treating Six Sigma as a holistic approach, investing adequate resources, focusing on customer requirements, usage of appropriate tools and techniques. Customer satisfaction is the key to success of any business today and in the future.

There are two methods namely “The Discrete Method” and “The Continuous Method” for calculating the performance in terms of the Sigma Level at any given point of time for a Six Sigma project. It has been found that fallacy exists in the Continuous Method of calculation.

Generally, the target denoted by “T” is fixed for a given project depending on the project objective. For example, the target for repair time to a customer call may be fixed as maximum 24 hours or lead-time of new product development may be fixed as maximum 45 working days or target for yield may be fixed as minimum 90%. Both the first and second cases are Lower the Better type and the last case is of Higher The Better type. Sigma Level/Sigma Rating is denoted by “Z”. Long term Sigma Level/Sigma Rating is denoted by Zₗₜ and Short term Sigma Level/Sigma Rating is denoted by Zₛₜ.
Zₗₜ=(Target−Average)/Standard deviation, when Project objective/CTQ characteristic is of “Lower the better” type having target “Maximum X (say)”.
Zₗₜ=(Average−Target)/Standard deviation, when Project objective/CTQ characteristic is of “Higher the better” type having target “Minimum X (say)”.
Also, Zₛₜ=Zₗₜ+1.5 (Short term Sigma Level=Long term Sigma Level+1.5).

In one embodiment, a method comprises the step of accepting as input a plurality of values associated with the product and/or service to be improved, subsequent to the completion of the quality monitoring method.

Subsequently, values associated with the product or service to be improved over a timeframe, comprising a plurality of time segments, such that each value corresponding to one among the plurality of time segments, is measured. Thereafter, a set of values among the plurality of values corresponding to the plurality of time segments, which correspond to a predefined criterion, are determined. Still further, parameters associated with the consistency of the values corresponding to the plurality of time segments are measured. Then, the measured parameters are processed arithmetically by applying predefined comparison criterion in accordance with two predominant system conditions. After the processing step is performed, a resultant parameter is obtained, whose variation indicates level of quality of product and/or service to be improved, by using the arithmetic combination of measured parameters, under the influence of set of predefined criterion. Finally, an output representing the resultant parameter for each of the time segments in the time frame is obtained.

In an embodiment, a computer-implemented system for monitoring quality in product and/or service associated projects by the application of improvement in Six Sigma methodology is provided. The system comprises means for accepting as input, a plurality of values associated with the product and/or service to be improved, subsequent to the completion of the quality monitoring method.

The system further comprises means for measuring values associated with the product or service to be improved over a timeframe comprising a plurality of time segments, such that each value corresponds to one among the plurality of time segments. The system further comprises means for determining a set of values among the plurality of values corresponding to the plurality of time segments, which correspond to a predefined criterion. The system further comprises means for measuring parameters associated with the consistency of the values corresponding to the plurality of time segments. The system further includes means for processing the measured parameters arithmetically by applying predefined comparison criterion in accordance with two predominant system conditions. The system further includes means for obtaining a resultant parameter, whose variation indicates level of quality of product and/or service to be improved, by using the arithmetic combination of measured parameters, under the influence of set of predefined criteria. The system further includes means for obtaining an output representing the resultant parameter for each of the time segments in the time frame.

In an embodiment, the output is implemented in the form of a visual representation to monitor the progress of product and/or service associated projects to be improved. In an embodiment, the parameter associated with the consistency is the standard deviation. In an embodiment, the values that are input in the system are the Average, Ideal Value, Target Value and Standard Deviation associated with the product and/or service to be improved. In an embodiment, the two predominant system conditions are “Higher the better” and “Lower the better”. In an embodiment, the output is in the form of a tabular format containing the values of the parameter whose variation indicates level of quality of product and/or service to be improved. In an embodiment, the output for the Capability Measurement Diagram is in graphical format. In an embodiment, the Six Sigma values are represented as standard notations along with different colored shades. In an embodiment, the colored shades represent regions of process deterioration and improvement. In an embodiment, the thick broken line represents the desired direction of improvement.

The fallacy in the conventional method to calculate Sigma Level with the following example for Case: Project objective/CTQ characteristic is of “Lower the better” type having target “Maximum X (say)”.

The target for the service time to a customer order for food in a hotel is maximum 30 minutes (or target for schedule variance of a software projects is 30%) and the present average is 45 minutes (or 45% in software projects) and the Hotel management (or Software Company) wants to increase the customer satisfaction level by achieving target of maximum 30 minutes (or 30% in software projects) to start with.

This Six Sigma project was initiated by forming a team for example in January, 2003. It will be apparent to a person skilled in the art that examples mentioned herein, and through the specification are for the purpose of illustration only, and are not to be construed as restricting the scope of the claims in any manner. For instance, the system under study may pertain to service time with regard to a customer order in a Hotel. The same applies to the Software schedule variance example for software projects in Software Companies.

Data collected for the period October to December 2002 indicates an average of 45 minutes and a Standard deviation of 5 minutes. The base sigma level before the commencement of the project works out to be −1.5 (Short term Sigma Level=Long term Sigma Level+1.5). This is taken as the Base Sigma Level.

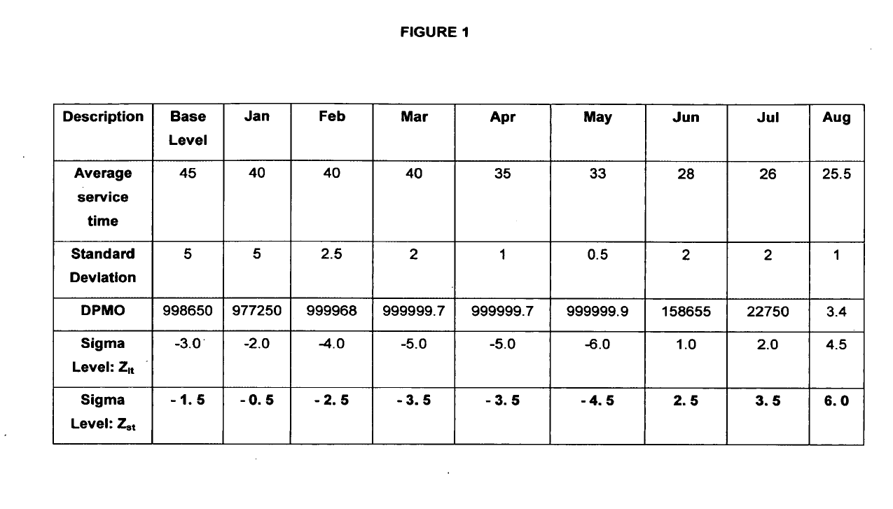

Let us assume the team members met regularly and devoted adequate time and resources for the project in identifying weak areas and taking corrective actions. Let us assume the progress of the project team is as illustrated in conjunction with FIG. 1.

FIG. 1. is a tabular representation of a system depicting the output in accordance with the conventional procedure for the “lower the better” criterion.

Further, let us assume the team identified weak areas and took some corrective actions in first week of January 2003. As a result let us say the average is 40 minutes and the Standard deviation is 5 minutes. The Sigma level now works out to be −0.5 (short term Sigma level).

The team continues identifying and taking corrective actions. In February, let us assume there is no change in the average value of time to service but there is a reduction in standard deviation to 2.5 as against the value of 5 in January. This is a significant achievement by the team. But the Sigma level now works out to be −2.5 (short term Sigma level) a lower value as compared to the value of −0.5 in January even though there was a significant improvement in the process namely reduction of the standard deviation or variation.

In the conventional method of calculating Sigma level, it can be observed that the observation of merely the Sigma level could not be truly indicative of the substantial improvement to the project team till the average crosses the target. Even though there is a real improvement (reduction of variation) in February as compared to January the Sigma level indicates the contrary. Same is the situation between February and March, wherein there is a reduction in variation, but the Sigma level indicates a lower value.

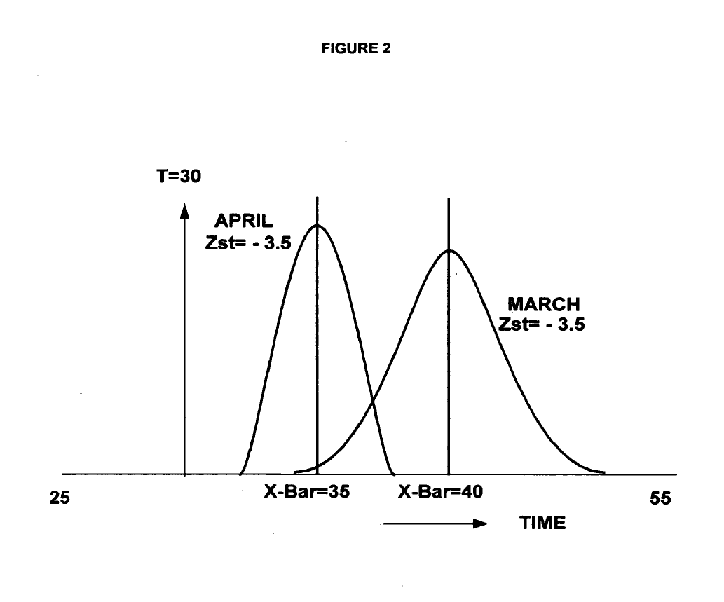

In April, there is reduction in both average time taken as well as variation (standard deviation) as compared to March, but the Sigma level remains same (−3.5) as seen in FIG. 2. The reason for this is that the area of the distribution of both months on the right and left side of target is the same. As a result, the use of discrete method (DPMO) of sigma level calculation to overcome this fallacy is also a gross error and should not be used as can be clearly understood in conjunction with FIG. 2.

FIG. 2 is a graphical bell curve representation of a system depicting the output in accordance with the conventional procedure for the “lower the better” criterion.

In May again, there is reduction in both average time taken as well as variation (standard deviation) as compared to April, but the Sigma level has reduced (from −3.5 to −4.5) even though there is a real improvement (reduction of variation from I to 0.5 and average service time from 35 to 33) in May as compared to April.

Only from the month June onwards, the Sigma level reflects the true performance because the average has become less than the target value. Hence it can be concluded that till the average crosses over (becomes less than) the target, the Sigma level is misleading and does not reflect true performance.

In an embodiment of the process disclosed herein, a novel method to calculate the performance for any project with project objective of “Lower the better” type having target as “Maximum X (say)” has been devised and implemented by deploying software.

### Method 1:

Use of loss as a means to monitor the progress of projects for cases where project objective is of “Lower the better” type having target as “Maximum X (say)” using the formula

Loss=(Average)²+(Standard Deviation)²

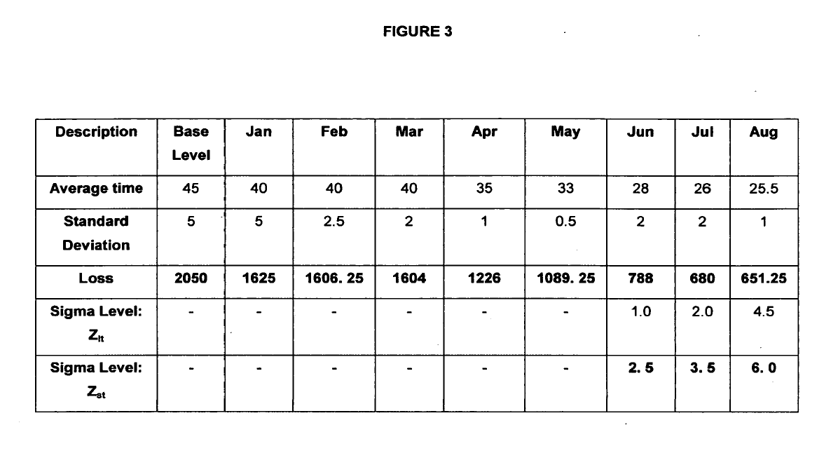

till the average crosses the target to visualize the performance and to use the existing method after the average crosses the target value as shown in FIG. 3. The loss for various months are shown in FIG. 3 and reduction in the loss value indicates process improvement. FIG. 3 is a tabular representation of a system, depicting the output in accordance with the disclosed processed for the “Lower the Better” criterion. It can be seen from FIG. 3, that the loss is continuously reducing from January to May indicating a good performance. Once the average has crossed the target value, (30 in this case) the normal method of Sigma level calculation indicates improvement from June to August.

The method is deployed when there is a reduction in any one or both the average and standard deviation in any month as compared to the previous month's values and cannot be used in cases where there is an increase in any one that is average or standard deviation and decrease in the other when compared with the previous month's values.

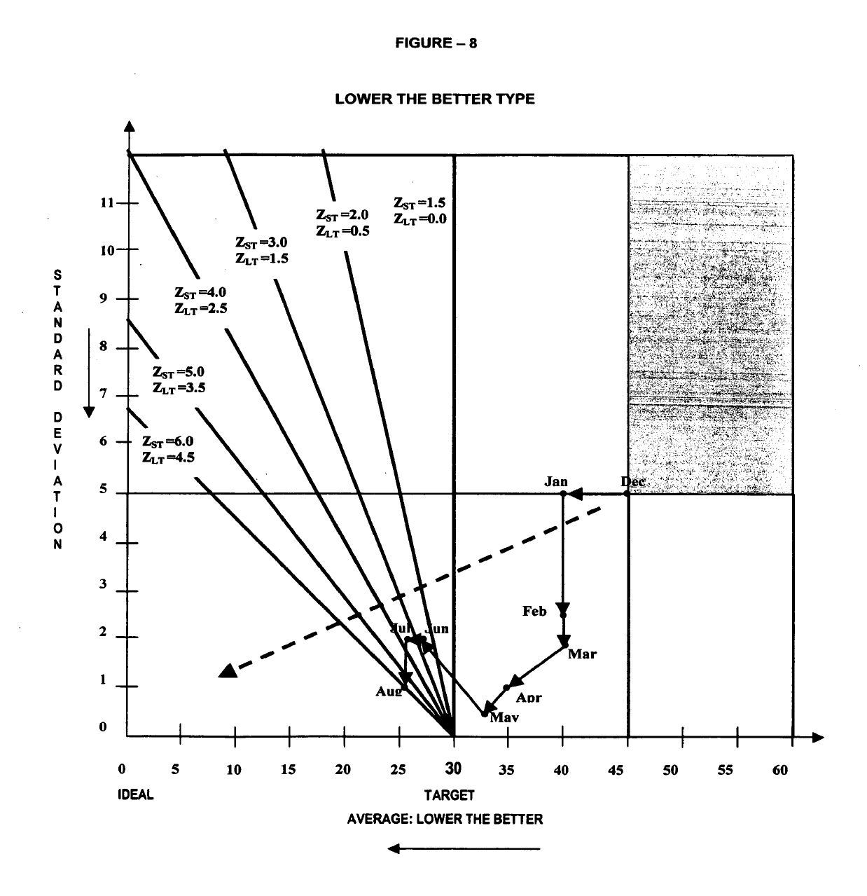

In another embodiment, use of Capability Measurement Software depicting the Capability Measurement Diagram as a means to monitor the progress of projects is performed in conjunction with FIG. 8.

The “Capability Measurement Diagram” and the related “Moving Loss” are used to monitor the performance of Six Sigma projects/other projects at any point of time during project progress. Capability Measurement Diagram for “Lower the better type” CTQ (Critical To Quality) Characteristic is shown in FIG. 8.

As it can be seen in the Capability Measurement Diagram example in conjunction with FIG. 8, the target for the project is 30 minutes (as indicated by a solid vertical line). Any point on this black color target line indicates a “Long term Sigma Level”, Zlt=0.0 and corresponding “Short term Sigma Level”, Zst=1.5.

Similarly, another solid line indicates a “Long term Sigma Level”, Zlt=0.5 and “Short term Sigma Level”, Zst=2. Another solid line indicates a “Long term Sigma Level”, Zlt=1.5 and “Short term Sigma Level”, Zst=3. Another solid line indicates a “Long term Sigma Level”, Zlt=2.5 and “Short term Sigma Level”, Zst=4. Another solid line indicates a “Long term Sigma Level”, Zlt=3.5 and “Short term Sigma Level”, Zst=5. Another solid line indicates a “Long term Sigma Level”, Zlt=4.5 and “Short term Sigma Level”, Zst=6.

Hence as mentioned earlier, the Sigma Level is meaningful when the average value becomes less than the target value of 30 minutes in this example of service time (continuous CTQ Characteristic of lower the better type). When the average value is larger than the target value, the Sigma Level calculated is not truly indicative of the substantial improvement.

Hence, in this region the “Moving Loss” is calculated to determine if there is improvement or not, in the CTQ Characteristic/Objective, compared to the corresponding previous month. Reduction in the “Loss value” for any month, when compared to the corresponding previous month's “Loss value” indicates improvement.

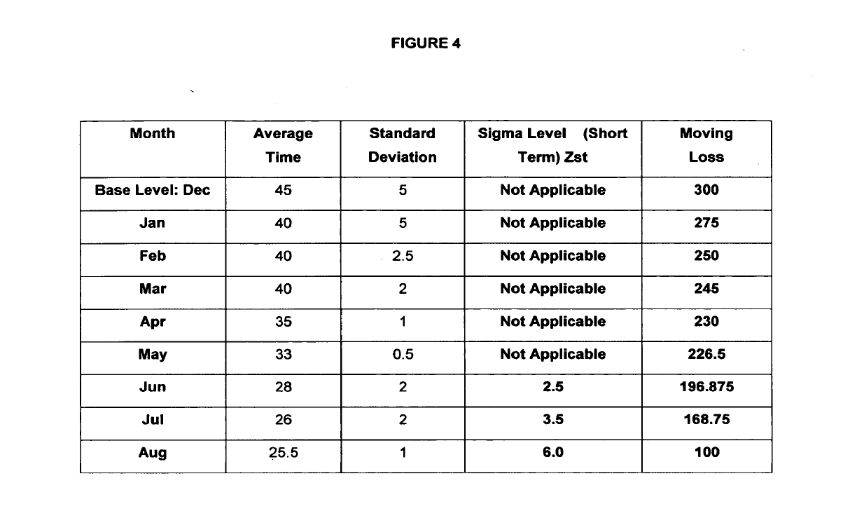

The logic deployed in “Moving Loss” calculations when the CTQ Characteristic is of “Lower the better type”, is as described as follows:
a) There will be a reduction in loss value for any month as compared to the corresponding previous month's loss value, if there is a reduction in either any one namely “Average” or “Standard deviation” (with the other remaining constant).
b) There will be a reduction in loss value for any month as compared to the corresponding previous month's loss value if there is reduction in both the “Average” and “Standard deviation”.
c) If there is increase in either any one namely “Average” or “Standard deviation” (with the other remaining constant) the loss value for that month will be more as compared to the corresponding previous month's loss value.
d) If there is increase in either any one namely “Average” or “Standard deviation” (with reduction in the other) the loss value for that month will be more as compared to the corresponding previous month's loss value.
e) If there is increase in both the “Average” and the “Standard deviation” the loss value for that month will be more as compared to the corresponding previous month's loss value. The “Moving Loss” for different months based on the above logic can be observed in conjunction with FIG. 4.

FIG. 4 is a tabular representation of a system depicting the output in accordance with an embodiment for the “Lower the Better” criterion.

Also as seen in FIG. 8, with reference to the first month's (December in this example) parameter values namely, average service time of 45 minutes and a standard deviation of 5 minutes, there are three regions namely red, yellow and green.

When compared with the first month's point (December in this example), all points in the red and yellow regions (representing increase in both or any one of the average and standard deviation respectively) indicates process deterioration.

When compared with the first month's point (December in this example), all points in the green region (representing decrease in any one with the other remaining constant or reduction in both the average and standard deviation) indicates process improvement. The thick broken line represents the required direction of improvement.

Hence, the use of the “Capability Measurement Diagram” and “Moving Loss” reflects the true performance and does not mislead the project team or the management.

The logic described below is utilized in visually representing the capability measurement diagram and moving loss calculations when continuous CTQ characteristic/objective of interest is of “Lower the Better” type.

The notations employed in the below mentioned logic in visually representing the Capability Measurement Diagram and Moving Loss calculations when continuous CTQ characteristic/objective of interest is of “Lower the Better” type are depicted below.

### Notations Used:

Target Value: TV
Ideal Value: IV=0.0
1^{st} Month Average: AVG1
2^{nd} Month Average: AVG2
. . . and so on till,
12^{th} Month Average: AVG12
Lowest Average Value in the data: AVG-Lowest
Highest Average Value in the data: AVG-Highest
Minimum Average value on X-Axis: AVG-Min
Maximum Average value on X-Axis: AVG-Max
1^{st} Month Standard Deviation: SD1
2^{nd} Month Standard Deviation: SD2
. . . and so on till
12^{th} Month Standard Deviation: SD12
Lowest Standard Deviation Value in the data: SD-Lowest
Highest Standard Deviation Value in the data: SD-Highest
Minimum Standard Deviation Value on Y-Axis: SD-Min
Maximum Standard Deviation Value on Y-Axis: SD-Max
Average at SD-Max equivalent to Sigma Level of 2 (Zlt=0.5; Zst=2): AVG-SL2
Average at SD-Max equivalent to Sigma Level of 3 (Zlt=1.5; Zst=3): AVG-SL3
Average at SD-Max equivalent to Sigma Level of 4 (Zlt=2.5; Zst=4): AVG-SL4
Average at SD-Max equivalent to Sigma Level of 5 (Zlt=3.5; Zst=5): AVG-SL5
Average at SD-Max equivalent to Sigma Level of 6 (Zlt=4.5; Zst=6): AVG-SL6
Standard Deviation at Ideal Value (IV) equivalent to Sigma Level of 2 (Zlt=0.5;Zst=2): SD-SL2
Standard Deviation at Ideal Value (IV) equivalent to Sigma Level of 3 (Zlt=1.5;Zst=3): SD-SL3
Standard Deviation at Ideal Value (IV) equivalent to Sigma Level of 4 (Zlt=2.5;Zst=4): SD-SL4
Standard Deviation at Ideal Value (IV) equivalent to Sigma Level of 5 (Zlt=3.5;Zst=5): SD-SL5
Standard Deviation at Ideal Value (IV) equivalent to Sigma Level of 6 (Zlt=4.5;Zst=6): SD-SL6
Loss calculated for the 1^{st} Month: Loss-1
Loss calculated for the 2^{nd} Month: Loss-2
Loss calculated for the Ith Month: Loss-(I)
Long term Sigma Level for 1^{st} Month: Zlt-1
Short term Sigma Level for 1^{St} Month: Zst-1
Long term Sigma Level for 2^{nd} Month: Zlt-2
Short term Sigma Level for 2^{nd} Month: Zst-2
Long term Sigma Level for Ith Month: Zlt-(I)
Short term Sigma Level for Ith Month: Zst-(I)
Average at SD-Max equivalent to 1^{st} Month Data: AVGHigh1
Average at SD-Max equivalent to 2^{nd} Month Data: AVGHigh2
Average at SD-Max equivalent to Ith Month Data: AVGHigh (I)
Standard Deviation at Ideal Value (IV) equivalent to 1^{st} Month Date: SDHigh 1.
Standard Deviation at Ideal Value (IV) equivalent to 2^{nd} Month Data: SDHigh 2.
Standard Deviation at Ideal Value (IV) equivalent to Ith Month Data: SDHigh (I).

### Method Used in Drawing the Capability Measurement Diagram

Find out lowest Average value from data entered and denote it as AVG-Lowest
Find out highest Average value from data entered and denote it as AVG-Highest
Find out lowest Standard Deviation value from data entered and denote it as SDlowest
Find out highest Standard Deviation value from data entered and denote it as SDHighest
AVG-Max=1.25×AVG-Highest
AVG-Min=IV(Ideal Value)=0.0
Draw X-Axis with origin point as AVG-Min and highest point equal to AVG-Max
SD-Max=2×SD-Highest
SD-Min=0.0
Draw V-Axis with origin point as SD-Min and highest point equal to SD-Max
Show the graduations on both the X-Axis and Y-Axis
Draw a vertical line at X-Axis point AVG-Max and horizontal line at Y-Axis at SD-Max to obtain the boundary box.
Draw a vertical line at X-Axis point TV till it meets the upper horizontal boundary line and denote it as Zlt=0 and Zst=1.5
AVG-SL2=TV−0.5×SD-Max
If AVG-SL2>0.0 OR AVG-SL2=0.0 then,
Draw an inclined vertical line joining X-Axis point TV and AVG-SL2 (at SD-Max) and denote it as Zlt=0.5 and Zst=2.0.
Else If AVG-SL2<0.0 then,
SD-SL2=(SD-Max/(0.5×SD-Max))×(TV-IV)
Draw an inclined vertical line joining X-Axis point TV and SD-SL2 (at Ideal Value) and denote it as Zlt=0.5 and Zst=2.0
AVG-SL3=TV−1.5×SD-Max
If AVG-SL3>0.0 OR AVG-SL3=0.0 then,
Draw an inclined vertical line joining X-Axis point TV and AVG-SL3 (at SD-Max) and denote it as Zlt=1.5 and Zst=3.0
Else If AVG-SL3<0.0 then,
SD-SL3=(SD-Max/(1.5×SD-Max))×(TV-IV)
Draw an inclined vertical line joining X-Axis point TV and SD-SL3 (at Ideal Value) and denote it as Zlt=1.5 and Zst=3.0
AVG-SL4=TV−2.5×SD-Max
If AVG-SL4>0.0 OR AVG-SL4=0.0 then,
Draw an inclined vertical line joining X-Axis point TV and AVG-SL4 (at SD-Max) and denote it as Zlt=2.5 and Zst=4.0
Else If AVG-SL4<0.0 then,
SD-SL4=(SD-Max/(2.5×SD-Max))×(TV-IV)
Draw an inclined vertical line joining X-Axis point TV and SD-SL4 (at Ideal Value) and denote it as Zlt=2.5 and Zst=4.0
AVG-SL5=TV−3.5×SD-Max
If AVG-SL5>0.0 OR AVG-SL5=0.0 then,
Draw an inclined vertical line joining X-Axis point TV and AVG-SL5 (at SD-Max) and denote it as Zlt=3.5 and Zst=5.0
Else If AVG-SL5<0.0 then,
SD-SL5=(SD-Max/(3.5×SD-Max))×(TV-IV)
Draw an inclined vertical line joining X-Axis point TV and SD-SL5 (at Ideal Value) and denote it as Zlt=3.5 and Zst=5.0
AVG-SL6=TV−4.5×SD-Max
If AVG-SL6>0.0 OR AVG-SL6=0.0 then,
Draw an inclined vertical line joining X-Axis point TV and AVG-SL6 (at SD-Max) and denote it as Zlt=4.5 and Zst=6.0
Else If AVG-SL6<0.0 then, SD-SL6=(SD-Max/(4.5×SD-Max))×(TV-IV)
Draw an inclined vertical line joining X-Axis point TV and SD-SL6 (at Ideal Value) and denote it as Zlt=4.5 and Zst=6.0.

### Method of Plotting the Input Data Points on Diagram

Mark a point at AVG1 & SD1 and name it as 1^{st} Month (Say May if it is entered as first month in input screen)
Mark a point at AVG2 & SD2 and name it as 2^{nd} Month (Say June if it is entered as second month in input screen)
. . . and so on till the last month is entered in input screen.
Join all the points joining from the first month till the last month.

### Logic Used in Moving Loss Calculation for Different Months

For 1^{st} Month Data:
If AVG1 >TV then
Loss−1 = (SD−Max X TV) + (AVG1−TV) X SD1
Else If AVG1 =TV then
Zlt−1 = 0.0 ; Zst−1 = 1.5 and
Loss−1 = (SD−Max X TV)
Else If AVG1 <TV then
BEGIN

Zlt−1 = (TV−AVG1)/SD1 and
Zst−1 Zlt−1 + 1.5 and
AVGHigh1 = TV − Zlt−1 X SD−Max and
If AVGHigh1 > 0.0 OR AVGHigh1 = 0.0 then
Loss−1 = (SD−Max X TV) − (0.5 X (TV − AVGHigh1) X SD−Max)
Else If AVGHigh1 <0.0
SDHigh1 = (SD−Max / (Zlt−1 X SD−Max)) X (TV−IV) and
Loss−1 = 0.5 X SDHigh1 X (TV−IV)

END.
For 2nd Month Data:
If AVG2>TVandAVG1 < TV OR AVG1 =TV then
Loss−2 = (SD−Max X TV) + (AVG2−TV) X SD2
Else If AVG2 > TV and AVG2 = AVG1 then
Loss−2 = (SD−Max X TV) + (AVG2−TV) X SD2
Else If AVG2 > TV and SD2 = SD1 then
Loss−2 = (SD−Max X TV) + (AVG2−TV) X SD2
Else If AVG2 > AVG1 and AVG1 > TV and SD2 < SD1 then
Loss−2 = Loss−1 + (AVG2−AVG1) X SD1 − (0.5 X (AVG2−AVG1) X (SD1 −SD2))
Else If AVG2 > AVG1 and AVG1 > TV and SD2 > SD1 then
Loss−2 = (SD−Max X TV) + ((AVG2−TV) X SD2)
Else If AVG2 > TV and AVG2 <AVG1 and SD2 > SD1 then
Loss−2 = Loss−1 + ((SD2−SD1) X (AVG1−TV)) − (0.5 X (SD2−SD1) X (AVGI−AVG2))
Else If AVG2 > TV and AVG2 <AVG1 and SD2 < SD1 then
Loss−2 = (SD−Max X TV) + ((AVG2−TV) X SD2)
Else If AVG2 = TV then
Zlt−2 = 0.0 ; Zst−2 = 1.5 and
Loss−2 = (SD−Max X TV)
Else If AVG2 <TV then
BEGIN

Zlt−2 = (TV−AVG2)/SD2 and
Zst−2 = Zlt−2 + 1.5 and
AVGHigh2 = TV − Zlt−2 X SD−Max and
If AVGHigh2 > 0.0 OR AVGHigh2 = 0.0 then
Loss−2 = (SD−Max X TV) − (0.5 X (TV − AVGHigh2) X SD−Max)
Else If AVGHigh2 <0:0
SDHigh2 = (SD−Max / (Zlt−2 X SD−Max)) X (TV−IV) and
Loss−2 = 0.5 X SDHigh2 X (TV−IV)

END.
For 3^{rd} Month till last Month Data:
For I = 3 TO N DO
If AVG(I) > TV and AVG(I−1) < TV OR AVG(I−1) = TV then
Loss−(I) = (SD−Max X TV) + (AVG(I)−TV) X SD(I)
Else If AVG(I) > TV and AVG(I) = AVG(I−1) then
Loss−(I) = (SD−Max X TV) + (AVG(I) −TV) X SD(I)
Else If AVG(I) > TV and SD(I) = SD(I−1)then
Loss−(I) = (SD−Max X TV) + (AVG(I)−TV) X SD(I)
Else If AVG(I) > AVG(I−1) and AVG(I−1) > TV and SD(I) < SD(I−1) then
Loss−(I)=Loss−(I−1)+(AVG(I)−AVG(I−1))X SD(I−1)−(0.5X(AVG(I)−AVG(I−1))X(SD(I−1)−
SD(I)))
Else If AVG(I) > AVG(I−1) and AVG(I−1) > TV and SD(I)> SD(I−1) then
Loss−(I) = (SD−Max X TV) + ((AVG(I)−TV) X SD(I))
Else If AVG(I) > TV and AVG(I) <AVG(I−1) and SD(I) > SD(I−1) then
Loss−(I) = Loss−(I−1) +
((SD(I)−SD(I−1))X(AVG(I−1)−TV))−(0.5X(SD(I)−SD(I−1))X(AVG(I−1)−AVG(I)))
Else If AVG(I) > TV and AVG(I) <AVG(I−1) and SD(I) <SD(I−1) then
Loss−(I) = (SD−Max X TV) + ((AVG(I)−TV) X SD(I))
Else If AVG(I) = TV then
Zlt−(I) = 0.0 ; Zst−(I) = 1.5 and
Loss−(I) = (SD−Max X TV)
Else If AVG(I) <TV then
BEGIN

Zlt−(I) = (TV−AVG(I))/SD(I) and
Zst−(I) = Zlt−(I) + 1.5 and
AVGHigh(I) = TV − Zlt−(I) X SD−Max and
If AVGHigh(I) > 0.0 OR AVG High(I) = 0.0 then
Loss−(I) = (SD−Max X TV) − (0.5 X (TV − AVGHigh(I)) X SD−Max)
Else If AVGHigh(I) <0.0
SDHigh(I) = (SD−Max / (Zlt−(I) X SD−Max)) X (TV−IV) and
Loss−(I) = 0.5 X SDHigh(I) X (TV−IV)

END.

The fallacy in the conventional procedure to calculate Sigma Level is described with the following example for Case: Project objective/CTQ characteristic is of “Higher the Better” type having target “Minimum X (say)”.

Let us say the target for the recovery of a product in a Company is minimum 90% (or target for right first time modules of software projects be 90%) and the present average recovery is 50% (or average is 50% right first time modules in software projects) and the Company Management (or Software Company) wants to increase the productivity by achieving target of minimum 90% to start with. This Six Sigma project was initiated by forming a team say in January, 2003. Let us now discuss only about recovery of a product in a company. The same applies to the % right first time modules example for software projects in Software Companies.

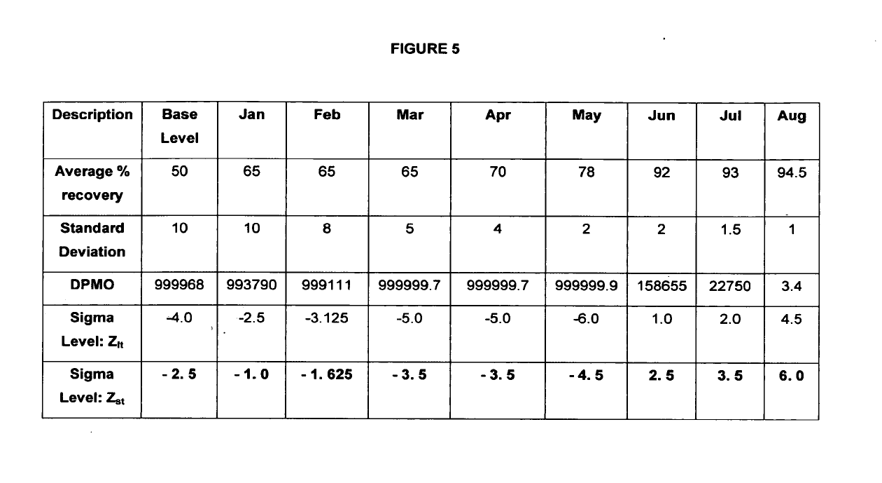

Data collected for the period October to December 2002 indicated an average of 50% recovery and a Standard deviation of 10. The base sigma level before the commencement of the project Works out to be −2.5 (short term sigma level). This is taken as the base sigma level. Let us assume the team members met regularly and devoted adequate time and resources for the project in identifying weak areas and taking corrective actions. Let us assume the progress of the project team is as given in FIG. 5.

FIG. 5 is a tabular representation of a system depicting the output in accordance with the conventional procedure for the “Higher the Better” criterion.

Let us assume the team identified weak areas and took some corrective actions in first week of January 2003. As a result let us say the average is 65% and Standard deviation is 10. The Sigma level now works out to be −1.0 (short term Sigma level).

The team continues to identify and take corrective actions. In February, let us assume there is no change in the average value of recovery but there is a reduction in standard deviation to 8 as against the value of 10 in January. This is a significant achievement by the team. But the Sigma level now works out to be −1.625 (short term Sigma level) a lower value as compared to the value of −1.0 in January even though there was a significant improvement in the process namely reduction of the standard deviation or variation. Same is the situation between February and March wherein there is a reduction in variation, but the Sigma level indicates a lower value.

The conventional method of calculating Sigma level does not indicate the accurate result to the team till the average crosses the target. Even though there is a real improvement (reduction of variation) in February as compared to January and March as compared to February the Sigma level indicates the contrary.

In April, there is both increase in average value of recovery as well as reduction of variation (standard deviation) as compared to March, (increase in average recovery from 65% to 70% and simultaneous reduction of variation from 5 to 4) but the Sigma level remains same. The reason for this is that the area of the distribution of both months on the right and left side of target is the same. Hence, the use of discrete method (DPMO) of Sigma level calculation to overcome this fallacy is also a gross error and should not be used. In May again, there is both increase in average recovery as well as reduction in variation (standard deviation) as compared to April, but the Sigma level has reduced (from −3.5 to −4.5) even though there is a real improvement (increase in average recovery from 70% to 78% and simultaneous reduction of variation from 4 to 2) in May as compared to April. Only from the month June onwards, the Sigma Level reflects the true performance because the average recovery has become more than the target value of 90%. Hence it can be concluded that till the average crosses over (becomes more than) the target, the Sigma level is misleading and does not reflect true performance.

The disclosed procedure follows which can be embodied in software to calculate the performance for any project with project objective of “Higher the Better” type having target as “Maximum X (say)”,

In an embodiment, a METHOD Loss is used as means to monitor the progress of projects for cases where project objective is of “Higher the better” type having target as “Maximum X (say)” using the formula

Loss=(Target−Average)²+(Standard Deviation)²

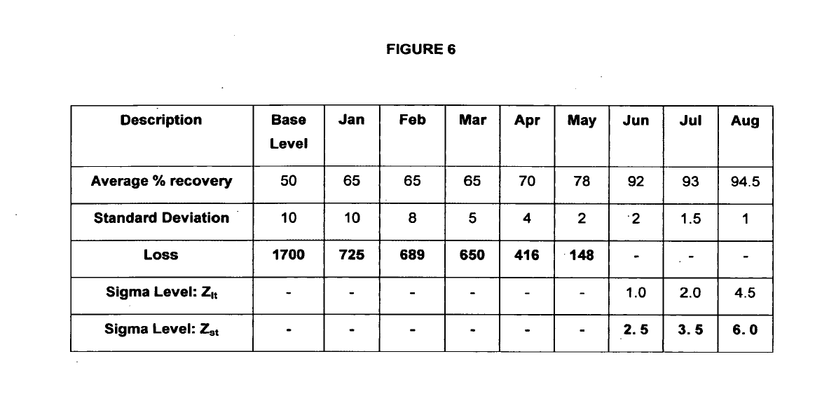

till the average crosses the target to visualize the performance and to use the existing method after the average crosses the target value as shown in FIG. 6.

Reduction in the loss value indicates process improvement as shown in FIG. 6. FIG. 6 is a tabular representation of a system depicting the output in accordance with an embodiment of the disclosed process for the “Higher the Better” criterion.

It can be seen from FIG. 6 that the loss is continuously reducing from January to May indicating good performance. Once the average has crossed the target value (90 in this case) the normal method of Sigma level calculation indicates improvement from June to August.

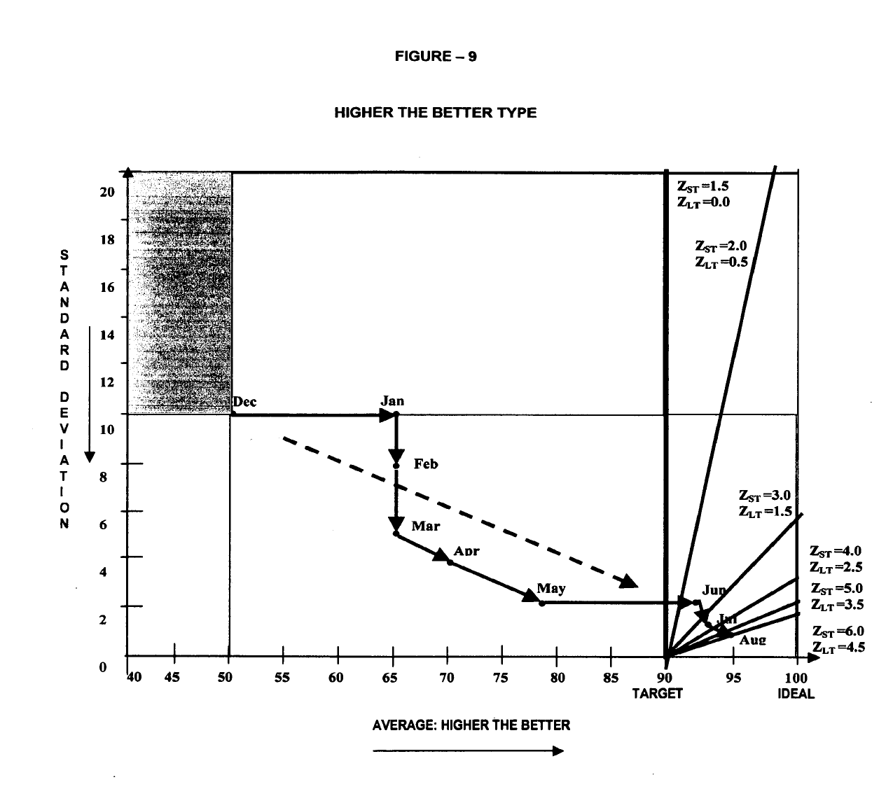

In a further embodiment, a method 2 for use of Capability Measurement Software depicting the Capability Measurement Diagram as a means to monitor the progress of projects is performed in conjunction with FIG. 9.

In a further embodiment, a “Capability Measurement Diagram” and the related “Moving Loss” can be used to monitor the performance of Six Sigma projects/other projects at any point of time during project progress. The Capability Measurement Diagram for “Higher the Better type” CTQ Characteristic is shown in FIG. 9.

FIG. 9 is a visual representation of a system depicting the output, in accordance with an embodiment for the “Higher the Better” criterion.

As seen in the Capability Measurement Diagram example in FIG. 9, the target for the project is 90% recovery (indicated by a solid vertical target line). Any point on this target line indicates a “Long term Sigma Level”, Zlt=0.0 and corresponding “Short term Sigma Level”, Zst=1.5. Similarly another solid line indicates a “Long term Sigma Level”, Zlt=0.5 and “Short term Sigma Level”, Zst=2. Another solid line indicates a “Long term Sigma Level”, Zlt=1.5 and “Short term Sigma Level”, Zst=3. Yet another solid line indicates a “Long term Sigma Level”, Zlt=2.5 and “Short term Sigma Level”, Zst=4. A solid line indicates a “Long term Sigma Level”, Zlt=3.5 and “Short term Sigma Level”, Zst=5. And another solid line indicates a “Long term Sigma Level”, Zlt=4.5 and “Short term Sigma Level”, Zst=6.

Hence as mentioned earlier the Sigma Level is meaningful when the average value becomes more than the target value of 90% recovery in this example of % recovery (continuous CTQ Characteristic of Higher the Better type). When the average value is smaller than the target value, the Sigma Level calculated is misleading and fallacious. Hence in this region the “Moving Loss” is calculated to check if there is improvement or not in the CTQ Characteristic/Objective as compared to the corresponding previous month. Reduction in the “Loss value” for any month when compared to the corresponding previous month's “Loss value” indicates improvement.

The logic deployed in calculating “Moving Loss” when the CTQ Characteristic is of “Higher the Better type” is as given below:
a) There will be a reduction in loss value for any month as compared to the corresponding previous month's loss value if there is an increase in the “Average” or decrease in the “Standard deviation” (with the other remaining constant),
b) There will be a reduction in loss value for any month as compared to the corresponding previous month's loss value if there is a increase in “Average” and reduction in “Standard Deviation”.
c) If there is reduction in “Average” or increase in “Standard Deviation” (with the other remaining constant) the loss value for that month will be more as compared to the corresponding previous month's loss value.
d) If there is increase in both the “Average” and “Standard Deviation” or decrease in both the “Average” and “Standard deviation” the loss value for that month will be more as compared to the corresponding previous month's loss value.
e) If there is reduction in the “Average” and increase in the “Standard Deviation” the loss value for that month will be more as compared to the corresponding previous month's loss value.

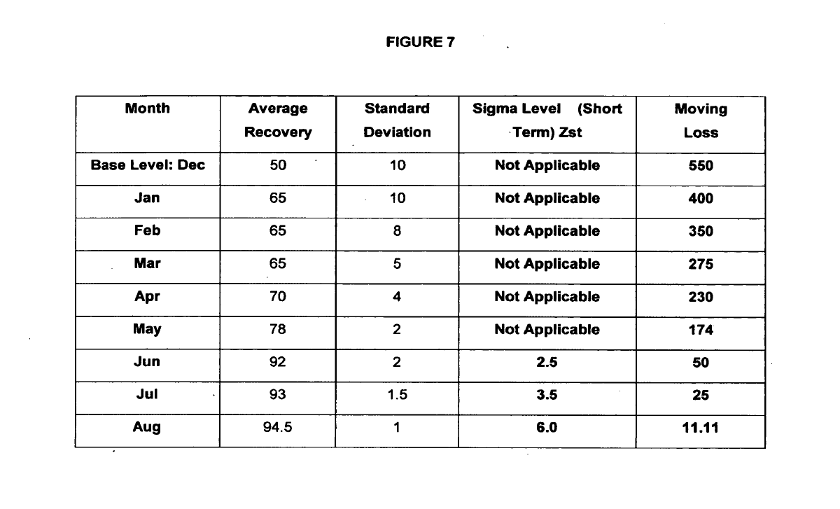

FIG. 7 shows the “Moving Loss” for different months based on the above logic, which is a tabular representation of a system, depicting the output in accordance with an embodiment for the “Higher the Better” criterion.

Also, as seen in FIG. 9, with reference to the first month's (December in this example) parameter values, namely Average % recovery of 50% and a Standard deviation of 10%, there are three regions namely red, yellow and green. When compared with the first month's point (December in this example), all points in the red and yellow regions indicate “process deterioration”. When compared with the first month's point (December in this example), all points in the green region indicates “process improvement”. The thick broken line represents the desired “direction of improvement”.

Hence the use of the “Capability Measurement Diagram” and “Moving Loss” reflects the true performance and does not mislead the project team or the management.

The logic used in drawing the Capability Measurement Diagram and Moving Loss calculations when continuous Critical to Quality (CTQ) characteristic/objective of interest is “Higher the Better” type as described in one embodiment.

### Notations Used:

Target Value: TV
Ideal Value: IV
1^{st} Month Average: AVG1
2^{nd} Month Average: AVG2
. . . and so on till
12^{th} month Average: AVG12
Lowest Average Value in the data: AVG-Lowest
Highest Average Value in the data: AVG-Highest
Minimum Average value on X-Axis: AVG-Min
Maximum Average value on X-Axis: AVG-Max
1^{St} Month Standard Deviation: SD1
2^{nd} Month Standard Deviation: SD2
. . . and-so on till
12^{th} Month Standard Deviation: SD12
Lowest Standard Deviation Value in the data: SD-Lowest
Highest Standard Deviation Value in the data: SD-Highest
Minimum Standard Deviation Value on Y-Axis: SD-Min
Maximum Standard Deviation Value on Y-Axis: SD-Max
Average at SD-Max equivalent to Sigma Level of 2 (Zlt=0.5 ; Zst=2): AVG-SL2
Average at SD-Max equivalent to Sigma Level of 3 (Zlt=1.5 ; Zst=3): AVG-SL3
Average at SD-Max equivalent to Sigma Level of 4 (Zlt=2.5; Zst=4): AVG-SL4
Average at SD-Max equivalent to Sigma Level of 5 (Zlt=3.5; Zst=5): AVG-SL5
Average at SD-Max equivalent to Sigma Level of 6 (Zlt=4.5; Zst=6): AVG-SL6
Standard Deviation at Ideal Value (IV) equivalent to Sigma Level of 2 (Zlt=0.5;Zst=2) SD-SL2
Standard Deviation at Ideal Value (IV) equivalent to Sigma Level of 3 (Zlt=1.5;Zst=3) SD-SL3
Standard Deviation at Ideal Value (IV) equivalent to Sigma Level of 4 (Zlt 2.5;Zst=4) SD-SL4
Standard Deviation at Ideal Value (IV) equivalent to Sigma Level of 5 (Zlt=3.5;Zst=5) SD-SL5
Standard Deviation at Ideal Value (IV) equivalent to Sigma Level of 6 (Zlt=4.5;Zst=6) SD-SL6
Loss calculated for the 1^{St} Month: Loss-1
Loss calculated for the 2^{nd} Month: Loss-2
Loss calculated for the Ith Month: Loss-(I)
Long term Sigma Level for 1^{st} Month: Zlt-1
Short term Sigma Level for 1^{st} Month: Zst-1
Long term Sigma Level for 2^{nd} Month: Zlt-2

Short term Sigma Level for 2^{nd} Month: Zst-2
Long term Sigma Level for Ith Month: Zlt-(I)
Short term Sigma Level for Ith Month: Zst-(I)
Average at SD-Max equivalent to 1^{st} Month Data: AVGHigh1
Average at SD-Max equivalent to 2^{nd} Month Data: AVGHigh2
Average at SD-Max equivalent to Ith Month Data: AVGHigh(I)
Standard Deviation at Ideal Value (IV) equivalent to 1^{st} Month Data: SDHigh1
Standard Deviation at Ideal Value (IV) equivalent to 2^{nd} Month Data: SDHigh2
Standard Deviation at Ideal Value (IV) equivalent to Ith Month Data: SDHigh(I)

### Method Used in Drawing the Capability Measurement Diagram

Find out lowest Average value from data entered and denote it as AVG-Lowest
Find out highest Average value from data entered and denote it as AVG-Highest
Find out lowest Standard Deviation value from data entered and denote it as SD-lowest
Find out highest Standard Deviation value from data entered and denote it as SDHighest
AVG-Max=Ideal Value=IV
AVG-Min=0.75×AVG-Lowest
Draw X-Axis with origin point as AVG-Min and highest point equal to AVG-Max
SD-Max=2×SD-Highest
SD-Min=0.0
Draw Y-Axis with origin point as SD-Min and highest point equal to SD-Max
Show the graduations on both the X-Axis and Y-Axis
Draw a vertical line at X-Axis point AVG-Max and horizontal line at V-Axis at SD-Max to obtain the boundary box
Draw a vertical line at X-Axis point TV till it meets the upper horizontal boundary line and denote it as Zlt=0 and Zst=1.5
AVG-SL2=TV+0.5×SD-Max
If AVG-SL2<IV OR AVG-SL2=IV then
Draw an inclined vertical line joining X-Axis point TV and AVG-SL2 (at SD-Max) and denote it as Zlt=0.5 and Zst=2.0
Else If AVG-SL2>IV then
SD-SL2=(SD-Max/(0.5×SD-Max))×(IV-TV)
Draw an inclined vertical line joining X-Axis point TV and SD-SL2 (at Ideal Value) and denote it as Zlt=0.5 and Zst=2.0
AVG-SL3=TV+1.5×SD-Max
If AVG-SL3<IV OR AVG-SL3=IV then
Draw an inclined vertical line joining X-Axis point TV and AVG-SL3 (at SD-Max) and denote it as Zlt=1.5 and Zst=3.0
Else If AVG-SL3>IV then
SD-SL3=(SD-Max/(1.5×SD-Max))×(IV-TV)
Draw an inclined vertical line joining X-Axis point TV and SD-SL3 (at Ideal Value) and denote it as Zlt=1.5 and Zst=3.0
AVG-SL4=TV+2.5×SD-Max
If AVG-SL4<IV OR AVG-SL4=IV then
Draw an inclined vertical line joining X-Axis point TV and AVG-SL4 (at SD-Max) and denote it as Zlt=2.5 and Zst=4.0
Else If AVG-SL4>IV then
SD-SL4=(SD-Max/(2.5×SD-Max))×(IV-TV)
Draw an inclined vertical line joining X-Axis point TV and SD-SL4 (at Ideal Value) and denote it as Zlt=2.5 and Zst=4.0
AVG-SL5=TV+3.5×SD-Max
If AVG-SL5<IV OR AVG-SL5=IV then
Draw an inclined vertical line joining X-Axis point TV and AVG-SL5 (at SD-Max) and denote it as Zlt=3.5 and Zst=5.0
Else If AVG-SL5>IV then
SD-SL5=(SD-Max/(3.5×SD-Max))×(IV-TV)
Draw an inclined vertical line joining X-Axis point TV and SD-SL5 (at Ideal Value) and denote it as Zlt=3.5 and Zst=5.0
AVG-SL6=TV+4.5×SD-Max
If AVG-SL6<IV OR AVG-SL6=IV then
Draw an inclined vertical line joining X-Axis point TV and AVG-SL6 (at SD-Max) and denote it as Zlt=4.5 and Zst=6.0
Else If AVG-SL6>IV then
SD-SL6=(SD-Max/(4.5×SD-Max))×(IV-TV)
Draw an inclined vertical line joining X-Axis point TV and SD-SL6 (at Ideal Value) and denote it as Zlt=4.5 and Zst=6.0

### Method of Plotting the Input Data Points on Diagram

Mark a point at AVG1 & SD1 and name it as 1^{st} Month (Say May if it is entered as first month in input screen)
Mark a point at AVG2 & SD2 and name it as 2^{nd} Month (Say June if it is entered as second month in input screen)
. . . and so on till
the last month is entered in input screen.
Join all the points joining from the first month till the last month.

### Logic Used in Moving Loss Calculation for Different Months

For 1^{st} Month Data:
If AVG1 <TV then
Loss−1 = (SD−Max X (IV−TV)) + (TV− AVG1) X SDI
Else If AVG1 = TV then
Zlt−1 = 0.0; Zst−1 = 1.5 and
Loss−1 = (SD−Max X (IV−TV))
Else If AVG1 > TV then
BEGIN

Zlt−1 = (AVG1−TV)/SD1 and
Zst−1 = Zlt−1 + 1.5 and
AVGHigh1 = TV + Zlt−1 X SD−Max and
If AVGHigh1 < IV OR AVGHighI = IV then
Loss−1 = (SD−Max X (IV−TV)) − (0.5 X (AVGHighI−TV) X SD−Max)
Else If AVGHigh1 > IV
SDHigh1 = (SD−Max / (Zlt−1 X SD−Max)) X (IV−TV) and
Loss−1 = 0.5 X SDHigh1 X (IV−TV)

END.
For 2nd Month Data:
If AVG2 < TV and AVG1 > TV OR AVG1 =TV then
Loss−2 = (SD−Max X (IV−TV)) + (TV−AVG2) X SD2
Else If AVG2 < TV and AVG2 = AVG1 then
Loss−2 = (SD−Max X (IV−TV)) + (TV−AVG2) X SD2
Else If AVG2 < TV and SD2 = SD1 then
Loss−2 = (SD−Max X (IV−TV)) − (TV−AVG2) X SD2
Else If AVG2 < AVG1 and AVG1 < TV and SD2 < SD1 then
Loss−2 = Loss−1 + (AVG1−AVG2) X SD1 − (0.5 X (AVG1−AVG2) X (SD1−SD2))
Else If AVG2 < AVG1 and AVG1 < TV and SD2 > SD1 then
Loss−2 = (SD−Max X (IV−TV)) + ((TV−AVG2) X SD2)
Else If AVG2 < TV and AVG2 > AVG1 and SD2 > SD1 then
Loss−2 = Loss−1 + ((SD2−SD1) X (TV−AVG1)) − (0.5 X (SD2−SD1) X (AVG2−AVG1))
Else If AVG2 <TV and AVG2 > AVG1 and SD2 <SD1 then
Loss−2 = (SD−Max X (IV−TV)) + ((TV−AVG2) X SD2)
Else If AVG2 = TV then
Zlt−2 = 0.0 ; Zst−2 = 1.5 and
Loss−2 = (SD−Max X (IV−TV))
Else If AVG2 > TV then
BEGIN

Zlt−2 = (AVG2−TV)/SD2 and
Zst−2 = Zlt−2 + 1.5 and
AVGHigh2 = TV + Zlt−2 X SD−Max and
If AVGHigh2 < IV OR AVGHigh2 = IV then
Loss−2 = (SD−Max X (IV−TV)) − (0.5 X (AVGHigh2−TV) X SD−Max)
Else If AVGHigh2 > IV
SDHigh2 = (SD−Max / (Zlt−2 X SD−Max)) X (IV−TV) and
Loss−2 = 0.5 X SDHigh2 X (IV−TV)

END.
For 3^{rd} Month till last Month Data:
If AVG(I) <TV and AVG(I−1) > TV OR AVG(I−1) = TV then
Loss−(I) = (SD−Max X (IV−TV)) + (TV−AVG(I)) X SD(I)
Else If AVG(I) < TV and AVG(I) = AVG(I−1) then
Loss−(I) = (SD−Max X (IV−TV)) + (TV−AVG(I)) X SD(I)
Else If AVG(I) < TV and SD(I) = SD(I−1) then
Loss−(I) = (SD−Max X (IV−TV)) + (TV−AVG(I)) X SD(I)
Else If AVG(I) < AVG(I−1) and AVG(I−1) < TV and SD(I) < SD(I−1) then
Loss−(I) = Loss−(I−1) + (AVG(I−1)−AVG(I)) X SD(I−1) − (0.5 X (AVG(I−1)−AVG(I)) X
(SD(I−1 ) − SD(I)))
Else If AVG(I) <AVG(I−1) and AVG(I−1) < TV and SD(I)> SD(I−1) then
Loss−(I) = (SD−Max X (IV−TV)) + ((TV−AVG(I)) X SD(I))
Else If AVG(I) < TV and AVG(I) > AVG(I−1) and SD(I) > SD(I−1) then
Loss−(I) = Loss−(I−1) + ((SD(I)−SD(I−1)) X (TV−AVG(I−1))) − (0.5 X (SD(I)−SD(I−1)) X
(AVG(I)−AVG(I−1)))
Else If AVG(I) < TV and AVG(I) > AVG(I−1) and SD(I) < SD(I−1) then
Loss−(I) = (SD−Max X (IV−TV)) + ((TV−AVG(1)) X SD(I))
Else If AVG(I) = TV then
Zlt−(I) = 0.0 ; Zst−(I) = 1.5 and
Loss−(I) = (SD−Max X (IV−TV))
Else If AVG(I) > TV then
BEGIN

Zlt−(I) = (AVG(1)−TV)/SD(1) and
Zst−(I) = Zlt−(I) + 1.5 and
AVG High(I) = TV + Zlt−(I) X SD−Max and
If AVGHigh(I) < IV OR AVGHigh(I) = IV then
Loss−(I) = (SD−Max X (IV−TV)) − (0.5 X (AVGHigh(I)−TV) X SD−Max)
Else If AVGHigh(I) > IV
SDHigh(I) = (SD−Max / (Zlt−(I) X SD−Max)) X (IV−TV) and
Loss−(I) = 0.5 X SDHigh(I) X (IV−TV)

END.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A computer-implemented method for monitoring quality in product and/or service associated projects by the application of improvement in Six Sigma methodology, the method comprising:
(a) accepting as input a plurality of values associated with the product and/or service to be improved, subsequent to the completion of the project;
(b) measuring values associated with the product and/or service to be improved over a timeframe comprising a plurality of time segments, such that each value corresponds to one among the plurality of time segments;
(c) determining a set of values among the plurality of values corresponding to the plurality of time segments which correspond to a predefined criterion;
(d) processing the set of values arithmetically by applying predefined comparison criterion in accordance with two predominant system conditions;
(e) obtaining a resultant parameter whose variation indicates level of quality of product and/or service to be improved by using the arithmetic combination of measured parameters, under the influence of set of predefined criterion;
(f) obtaining an output representing the resultant parameter for each of the time segments in the time frame.

2. The method as recited in claim 1, wherein the output is implemented in the form of a visual representation to monitor the progress of the product and/or service to be improved.

3. The method as recited in claim 1, wherein the values that are input in the system are the Average, Ideal Value, Target Value and Standard Deviation associated with the product and/or service to be improved.

4. The method as recited in claim 1, wherein the two predominant system conditions are “Higher the Better” and “Lower the Better”.

5. The method as recited in claim 1, wherein the output is in the form of a tabular format containing the values of the parameter as using “Moving Loss”, whose variation indicates level of quality of the product and/or service to be improved.

6. The method as recited in claim 1, wherein the output is for a Capability Measurement Diagram in graphical format.

7. The method as recited in claim 1, wherein the values are represented as standard notations along with different regions.

8. The method as recited in claim 7, wherein the regions represent regions of process deterioration and improvement.

9. A computer-implemented system for monitoring quality in product and/or service associated projects by the application of improvement in Six Sigma methodology, the system comprising:
(a) means for accepting as input a plurality of values associated with the product and/or service to be improved, subsequent to the completion of the project;
(b) means for measuring values associated with the product and/or service to be improved over a timeframe comprising a plurality of time segments, such that each value corresponds to one among the plurality of time segments;
(c) means for determining a set of values among the plurality of values corresponding to the plurality of time segments, which correspond to a predefined criterion;
(d) means for processing the set of values arithmetically by applying predefined comparison criterion in accordance with two predominant system conditions;
(e) means for obtaining a resultant parameter, whose variation indicates level of quality of the product and/or service to be improved, by using the arithmetic combination of measured parameters, under the influence of set of predefined criteria's;
(f) means for obtaining an output representing the resultant parameter for each of the time segments in the time frame.

10. The system as claimed in claim 9, wherein the means for measuring values, the means for determining a set of values among the plurality of values, the means for measuring parameters associated with the consistency of the values, the means for processing and the means for obtaining a resultant parameter are computer-implemented software mechanisms.

11. The system as claimed in claim 9, wherein the output is implemented in the form of a visual representation to monitor the progress of the product and/or service to be improved.

12. The system as claimed in claim 9, wherein the values that are input in the system are the Average, Ideal Value, Target Value and Standard Deviation associated with the product and/or service to be improved.

13. The system as claimed in claim 9, wherein the two predominant system conditions are “Higher the Better” and “Lower the Better”.

14. The system as claimed in claim 9, wherein the output is in the form of a tabular format containing the values of the parameter “Moving Loss” whose variation indicates level of quality of the product and/or service to be improved.

15. The system as claimed in claim 9, wherein the output is for a Capability Measurement Diagram in graphical format.
